(19) United States
(12) Patent Application Publication
(10) Pub. No.: US 2005/0127925 A1
(43) Pub. Date: Jun. 16, 2005

(54) Moisture sensor

(76) Inventor: Peter Ethan Staples, Hermosa Beach, CA (US)

Correspondence Address: SCHOX PLC, 209 NORTH STREET, #200, ANN ARBOR, MI, 48104, US

(21) Appl. No.: 10/731,904

(22) Filed: Dec. 10, 2003

(51) Int. Cl. G01N 27/12

(52) U.S. Cl. 324/694

(57) ABSTRACT

The moisture sensor 10 of the preferred embodiment includes a first platform 12, conductive traces 14, and a processor 16. The moisture sensor 10 can be inserted into the soil of a plant and used to measure the moisture in the soil. In the preferred embodiment, the moisture sensor 10 indicates the moisture in the soil of the plant. With this knowledge, a user can determine whether to hydrate the plant at any given time.

### TECHNICAL FIELD

This invention relates generally to moisture sensors, and more specifically to moisture sensors to be inserted into the soil of a plant.

### BRIEF DESCRIPTION OF THE FIGURES

FIG. 1 is a perspective view of the first platform, conductive traces, and a processor of the moisture sensor of the preferred embodiment.

FIG. 2 is a side view of the shaft housing, base housing, and shaft tip of the moisture sensor of the preferred embodiment.

FIG. 3 is a schematic drawing of the series involved in the preferred method of supplying the moisture sensors of the preferred embodiment.

### DESCRIPTION OF THE PREFERRED EMBODIMENTS

The following description of the preferred embodiment of the invention is not intended to limit the invention to this preferred embodiment, but rather to enable any person skilled in the art of moisture sensors to make and use this invention.

As shown in FIG. 1, the moisture sensor 10 of the preferred embodiment of the invention includes a first platform 12, conductive traces 14, and a processor 16. The moisture sensor 10 of the present invention has been specifically designed to be inserted into the soil of a plant. The moisture sensor 10 can be used to measure the moisture in the soil of a houseplant, such as a fichus plant, or an outdoor plant, such as rosebush. The moisture sensor 10 could, however, be used in other suitable environments for other suitable tasks. In the preferred embodiment of the invention, the moisture sensor 10 indicates the moisture in the soil of the plant. With this knowledge, a user can determine whether to hydrate the plant at any given time.

The first platform 12 of the preferred embodiment functions as a structural backing for the conductive traces 14. The first platform 12 preferably has an elongated shape, but may alternatively have any suitable shape. Preferably, the first platform 12 is a conventional circuit board and is made with similar methods and materials as conventional circuit boards. Alternatively, the first platform 12 can be made with any suitable method and any suitable material.

The conductive traces 14 of the preferred embodiment function to provide an electrical voltage for the processor 16, which can be used to estimate the moisture in the soil. In a first variation, the conductive traces 14 are disposed on a first surface 18 of the first platform 12. In a second variation, the conductive traces 14 are disposed on a first surface 18 of the first platform 12 and on a second surface 20 (opposite of the first surface 18) of the first platform 12. The printing of the conductive traces 14 on two surfaces of the circuit board can provide a more disperse and more accurate measurement of the moisture in the soil of the plant. Preferably, the conductive traces 14 are made from zinc and are made with similar methods as conventional conductive traces. Alternatively, the conductive traces 14 may be made from any suitable material that is non-corrodible, such as gold, and with any suitable method.

The processor 16 of the preferred embodiment functions to measure the electrical voltage across the conductive traces 14 and to calculate the moisture in the soil of the plant. The processor 16 is preferably connected to the conductive traces 14, either directly or through an electrical circuit, but may alternatively be connected to the conductive traces 14 through any suitable means. To provide an accurate calculation of the moisture in the soil, the processor 16 preferably includes a conventional analog-to-digital converter and a memory element with a lookup table for different types of plant soil. The processor 16 may, however, include any suitable means to provide an accurate conversion from the voltage in the conductive traces 14 to the calculation of the moisture in the soil of the plant.

The moisture sensor 10 of the preferred embodiment further includes a second platform 22, which functions as the structural backing for the processor 16. The second platform 22 preferably has a circular or square shape, but may alternatively have any suitable shape. The second platform 22 is preferably located adjacent and perpendicular to the first platform 12. Like the first platform 12, the second platform 22 is preferably a conventional circuit board and is preferably made with similar methods and materials of conventional circuit boards. Alternatively, the second platform 22 can be made with any suitable method and any suitable material. The processor 16 is preferably disposed on the second platform 22, but may alternatively be located in any suitable area of the moisture sensor 10.

The moisture sensor 10 of the preferred embodiment further includes an output device 24 connected to the processor 16, which functions to indicate the moisture in the soil of the plant to the user of the moisture sensor 10. In a first variation, the output device 24 is a conventional wireless transmitter (or other suitable signal transmitter) that sends a data signal of the moisture in the soil to another suitable device. In a second variation (not shown), the output device 24 is a conventional speaker (or other suitable audio device) that sounds an audible indicator of the moisture in the soil. In a third variation (not shown), the output device 24 is a conventional screen (or other suitable visual device) that displays a visual indicator of the moisture in the soil. In alternative variations, the output device 24 may be any suitable device that indicates the moisture in the soil of the plant to the user of the moisture sensor 10. The moisture sensor 10 may include more than one variation of the output device 24. The output device 24, which is connected to the processor 16, is preferably disposed on the second platform 22, but may alternatively be disposed in any suitable area of the moisture sensor 10.

The moisture sensor 10 of the preferred embodiment further includes a porous member 26, which functions to facilitate a uniform moisture transfer from the soil to the conductive traces 14. To connect the porous member 26 with the first platform 12, the porous member 26 is preferably molded around at least one hole 28 in the first platform 12. The porous member 26 may, however, be coupled with the first platform 12 with any suitable anchor defined by the first platform 12. The porous member 26 is preferably made from porous materials, such as gypsum, and is preferably made with conventional methods. The porous member 26 may alternatively be made from any suitable material and with any suitable method that produces a porous material that facilitates uniform moisture transfer from the soil to the conductive traces 14.

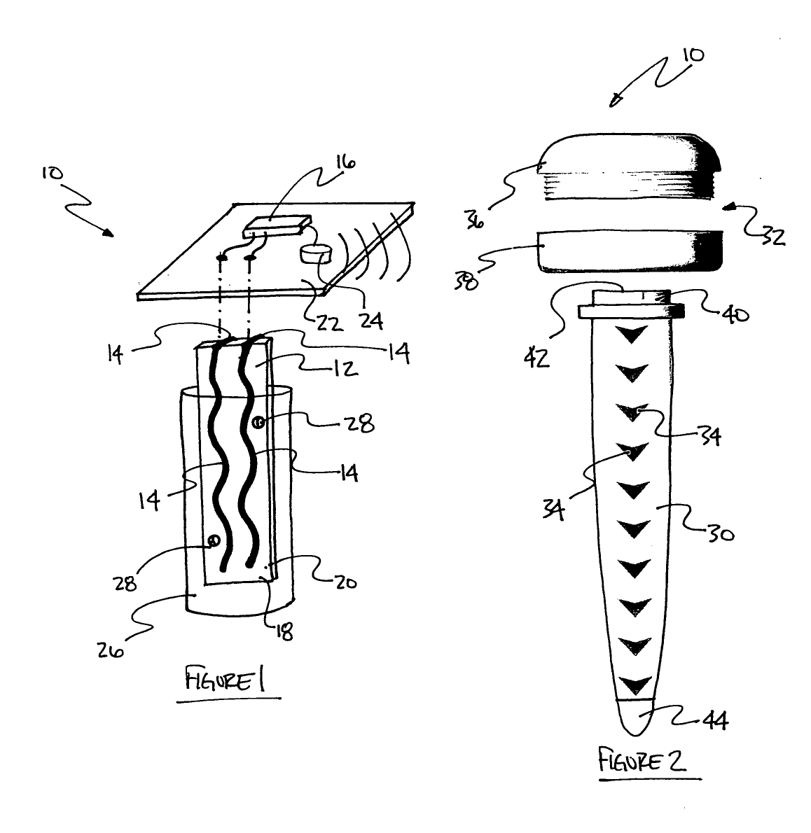

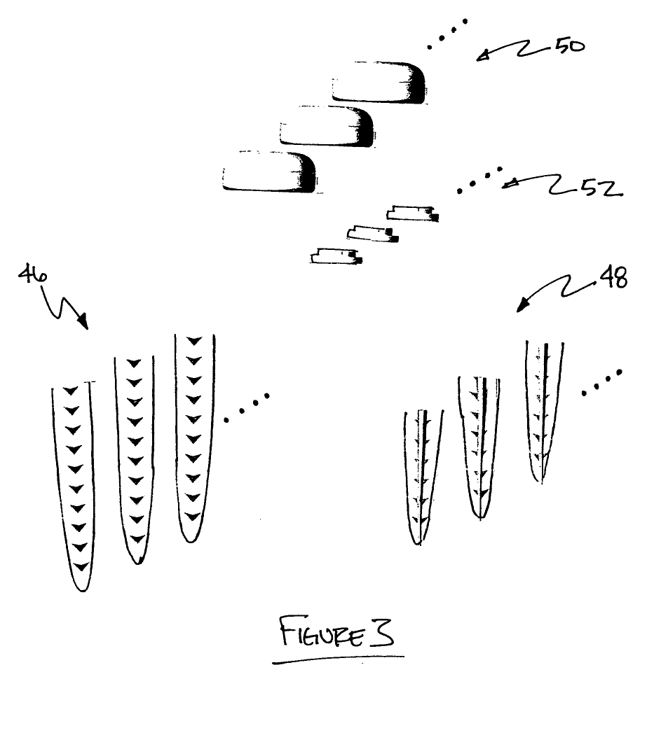

As shown in FIG. 2, the moisture sensor 10 of the preferred embodiment includes a shaft housing 30, which functions to contain and protect the first platform and the porous material, and a base housing 32, which function to contain and protect the second platform. The shaft housing 30 preferably includes a groove arrangement (not shown) that allows insertion and capture of the first platform, but the moisture sensor 10 may alternatively include any suitable element to couple the shaft housing 30 and the first platform. The shaft housing 30 preferably defines inlets 34, but may alternatively include any suitable device to facilitate moisture transfer from the soil to the conductive traces. The base housing 32 preferably includes three or more screw bosses (not shown) that allow insertion of a fastener, such as a screw, through the second platform and into the screw boss, but the moisture sensor 10 may alternatively include any suitable element to couple the base housing 32 and the second platform. Preferably, the base housing 32 includes a first section 36 and a second section 38 that are removably coupled with a threaded arrangement to allow access within the base housing 32. Alternatively, the first section 36 and the second section 38 could be coupled with other suitable devices, or the base housing 32 could include other means to allow access within the base housing 32. The base housing 32, unlike the shaft housing 30, preferably seals the second platform from environmental conditions, such as water.

The moisture sensor 10 of the preferred embodiment also includes a connector 40 that functions to removably connect the base housing 32 and the shaft housing 30. Preferably, the connector 40 is integrally formed with the shaft housing 30. Alternatively, the connector 40 may be integrally formed with the base housing 32, or the connector 40 may be formed separate from the shaft housing 30 and the base housing 32. In the preferred embodiment, the first platform, the second platform, and the connector 40 are configured to allow connection between the conductive traces and the processor upon the connection of the base housing 32 and the shaft housing 30. Such functionality is preferably accomplished through a tab arrangement 42 on the connector 40, but may alternatively be accomplished with any suitable device. The shaft housing 30, the base housing 32, and the connector 40 are preferably made from conventional plastics and made with conventional methods, but may alternatively be made from any suitable materials and with any suitable methods.

The moisture sensor 10 of the preferred embodiment also includes a shaft tip 44 coupled to the shaft housing 30, which functions to perforate the soil upon the insertion of the moisture sensor 10 into the soil. The shaft tip 44 is preferably integrally coupled to the shaft housing 30, but may be alternatively coupled to any suitable area of the moisture sensor 10 with any suitable fastener. The shaft tip 44 is preferably shaped like a flat arrow, but may alternatively be shaped like a so-called Phillips screwdriver. The shaft tip 44 may alternatively be shaped like any other suitable shape that allows easy perforation of the soil upon the insertion of the moisture sensor 10 into the soil. The shaft tip 44 is preferably made from conventional plastics and made with conventional methods, but may alternatively be made from any suitable materials and with any suitable methods.

As shown in FIG. 3, the moisture sensor of the preferred embodiment may be supplied by the following steps: (1) providing a first series of shaft units 46, each shaft unit including a first platform, conductive traces disposed on the first platform, and a shaft housing coupled to the first platform and adapted to facilitate moisture transfer from the soil to the conductive traces; (2) providing a second series of shaft units 48, each shaft unit including a first platform, conductive traces disposed on the first platform, and a shaft housing coupled to the first platform and adapted to facilitate moisture transfer from the soil to the conductive traces, wherein the shaft housings of the first series of shaft units 46 have a different cross-section than the shaft housings of the second series of shaft units 48; (3) providing a series of base units 50, each base unit including a second platform, a processor disposed on the second platform and configured to measure an electrical voltage across the conductive traces and to calculate the moisture in the soil of the plant, and a base housing coupled to the second platform and adapted to protect the second platform; and (4) providing a series of connectors 52, each connector selectively adapted to removably connect any base housing from the series of base units 50 and any shaft housing from the first series of shaft units 46 and to removably connect any base housing from the series of base units 50 and any shaft housing from the second series of shaft units 48. Preferably, a portion of the series of connectors 52 is integrally formed with the first series of shaft units 46 and another portion of the series of connectors 52 is integrally formed with the second series of shaft units 48. Alternatively, the series of connectors 52 could be integrally formed with the series of base units 50, or the series of connectors 52 could be formed separate from the shaft units and the base units. By using the preferred method, the economies of scale of the shared base units are realized while the individual requirements of different soils and different plants are met.

Of course, other suitable steps may be added to the preferred method. For example, a first series of porous members (not shown) may be supplied with the first series of shaft units 46, while a second series of porous members (not shown) may be supplied with the second series of shaft units 48. In one variation, the first and second series of porous members may be made from the same composition to increase manufacturing efficiency. In another variation, the first and second series of porous members may be made from a slightly different composition to more effectively facilitate a uniform moisture transfer from the soil of the specific plant for which the shaft units were designed.

As a person skilled in the art of moisture sensors will recognize from the previous detailed description and from the figures and claims, modifications and changes can be made to the preferred embodiment of the invention without departing from the scope of this invention defined in the following claims.

1. A moisture sensor to be inserted into the soil of a plant, comprising:
a first platform;
conductive traces disposed on the first platform; and
a processor coupled to the conductive traces and configured to measure an electrical voltage across the conductive traces and to calculate the moisture in the soil of the plant.

2. The moisture sensor of claim 1 wherein the first platform is a circuit board.

3. The moisture sensor of claim 2 wherein the conductive traces are disposed on a first surface of the circuit board and on a second surface of the circuit board.

4. The moisture sensor of claim 1 further comprising a porous member coupled to the first platform and arranged to facilitate moisture transfer from the soil to the conductive traces.

5. The moisture sensor of claim 4 wherein the first platform defines an anchor; and wherein the porous member is mounted to the anchor.

6. The moisture sensor of claim 4 further comprising a shaft housing coupled to the first platform and adapted to facilitate moisture transfer from the soil to the conductive traces.

7. The moisture sensor of claim 6 further comprising a shaft tip coupled to the shaft housing and adapted to perforate the soil upon the insertion of the moisture sensor into the soil.

8. The moisture sensor of claim 1 further comprising a second platform; wherein the processor is disposed on the second platform.

9. The moisture sensor of claim 8 further comprising an output device disposed on the second platform and connected to the processor.

10. The moisture sensor of claim 9 wherein the output device is a wireless transmitter.

11. The moisture sensor of claim 8 further comprising a base housing coupled to the second platform and adapted to protect the second platform.

12. The moisture sensor of claim 11 further comprising a shaft housing coupled to the first platform and adapted to facilitate moisture transfer from the soil to the conductive traces.

13. The moisture sensor of claim 12 further comprising a connector adapted to removably connect the base housing and the shaft housing.

14. The moisture sensor of claim 13 wherein the connector is formed separate from the shaft housing and the base housing.

15. The moisture sensor of claim 13 wherein the first platform, the second platform, and the connector are configured to allow connection between the conductive traces and the processor upon the connection of the base housing and the shaft housing.

16. A method of providing a moisture sensor to be inserted into the soil of a plant, comprising the following steps:
providing a first series of shaft units, each shaft unit including a first platform, conductive traces disposed on the first platform, and a shaft housing coupled to the first platform and adapted to facilitate moisture transfer from the soil to the conductive traces;
providing a second series of shaft units, each shaft unit including a first platform, conductive traces disposed on the first platform, and a shaft housing coupled to the first platform and adapted to facilitate moisture transfer from the soil to the conductive traces, wherein the shaft housings of the first series of shaft units have a different cross-section than the shaft housings of the second series of shaft units;
providing a series of base units, each base unit including a second platform, a processor disposed on the second platform and configured to measure an electrical voltage across the conductive traces and to calculate the moisture in the soil of the plant, and a base housing coupled to the second platform and adapted to protect the second platform; and
providing a series of connectors, each connector selectively adapted to removably connect any base housing from the series of base units and any shaft housing from the first series of shaft units and to removably connect any base housing from the series of base units and any shaft housing from the second series of shaft units.

17. The method of claim 16, wherein the series of connectors are formed separate from the first series of shaft units, from the second series of shaft units, and from the series the base units.
